(19) United States
(12) Patent Application Publication
(10) Pub. No.: US 2004/0072042 A1
(43) Pub. Date: Apr. 15, 2004

(54) Fuel cell system

(76) Inventor: Soo-Whan Kim, Seongnam-city (KR)

Correspondence Address: MORGAN, LEWIS & BOCKIUS, LLP., 3300 HILLVIEW AVENUE, PALO ALTO, CA, 94304, US

(21) Appl. No.: 10/454,959

(22) Filed: Jun. 3, 2003

(30) Foreign Application Priority Data
Oct. 15, 2002 (KR) 10-2002-0062926

(51) Int. Cl. H01M 8/04; H01M 8/10

(52) U.S. Cl. 429/23; 429/32; 429/34

(57) ABSTRACT

The fuel cell system includes a membrane/electrode assembly, a fuel cell stack, an electrical load, a switch, and a control unit. The fuel cell stack includes a plurality of fuel cells, and the electrical load is selectively electrically connectable to the fuel cell stack through the switch which is actuated by a control signal of the control unit, and the control unit is configured to generate a control signal for turning on the switch when a shutdown of the fuel cell stack occurs.

### FIELD OF THE INVENTION

The present invention relates to a fuel cell system, and more particularly, to a system for making a fuel cell inert by rapidly removing hydrogen from a fuel cell stack.

### BACKGROUND OF THE INVENTION

Fuel cells are electrochemical power sources for both stationary and mobile applications, and as such, they may be used for automotive applications.

One type of fuel cell employing a solid polymer electrolyte is widely known to have promise as a power source for vehicles and for stationary applications under 200 kW.

Fuel cells for vehicles have a drawback, compared to fuel cells for stationary applications, because they typically experience frequent shutdown and startup. A polymer electrolyte that operates well in a lower temperature range, especially below 100° C., is good for fuel cells for vehicles, but during shutdown and startup, special treatment is required.

A fuel cell employing a polymer electrolyte (polymer electrolyte fuel cell) has a membrane/electrode assembly which includes a polymer electrolyte membrane and a pair of electrodes. The polymer electrolyte membrane allows only hydrogen ions to pass therethrough, and the electrodes are respectively disposed on each side of the polymer electrolyte membrane.

Gas diffusion media are disposed on both sides of the membrane/electrode assembly. The gas diffusion media are provided to diffuse air and fuel gas.

A cooling plate including an anode flow field plate and a cathode flow field plate is disposed adjacent to the gas diffusion media. If hydrogen is supplied to one side of the membrane/electrode assembly, and oxygen is supplied to the other side of the membrane/electrode assembly, the fuel cell generates electricity. During the generation of electricity, hydrogen is divided into hydrogen ions and electrons at an anode electrode. The hydrogen ions pass through the polymer electrolyte membrane, and the hydrogen ions, electrons, and oxygen are coupled to generate water at a cathode electrode.

The electrodes include a catalyst layer for electrochemical reactions, and porous carbon supports for collecting electrons. To maximize the reaction area, the electrodes are made by scattering the catalyst, such as platinum, on the carbon supports, and the membrane/electrode assembly is made by sandwiching the polymer electrolyte membrane with the electrodes.

Further, in a fuel cell employing a polymer electrolyte, in order to secure stable operation and to increase lifespan of the fuel cell, oxygen must not be supplied between an anode electrode and an anode flow field during shutdown or startup. That is, it is necessary to make the fuel cell inert at those times to prevent undesirable processes and/or reactions.

Accordingly, an inert gas, such as Nitrogen, is typically supplied to the fuel cell during startup or shutdown in order to make the fuel cell inert. However, it is problematic to transport a nitrogen gas source in an automotive vehicle, so other means are required.

Further, during shutdown, instead of a nitrogen purge to separate ambient air, gases flow through the membrane/electrode assembly because of a difference of partial pressures of hydrogen, nitrogen, and oxygen on both sides of the membrane/electrode assembly. Consequently, undesired reactions may occur in an anode side of fuel cell stack.

In a fuel cell system described in U.S. Pat. No. 6,379,827, a wettable gas diffusion media is positioned between a hydrogen electrode and an anode flow field. The gas diffusion media is filled with coolant water that is drawn into pores of the gas diffusion media by capillary forces so that air is prevented from reaching the electrodes. However, in order to employ porous separation plates and utilize capillary forces, there are drawbacks in that precise control of an anode, a cathode, and coolant water pressure is required.

A fuel cell system according to U.S. Pat. No. 5,013,617 employs a phosphoric acid fuel cell, which operates at around 200° C. When the voltage of the unit fuel cell is higher than 0.8V, oxidation of carbon occurs. Accordingly, an inert gas purge is needed during shutdown of the fuel cell in order to maintain the voltage within a range of 0.3V and 0.8V. The fuel cell system includes a load in order to maintain the voltage, that is, in order to prevent oxidation of the carbon.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

Therefore, a motivation of the present invention is to provide a fuel cell system in which an inert state in an anode and a cathode of a fuel cell stack can be maintained during startup or shutdown of a polymer electrolyte fuel cell.

In a preferred embodiment of the present invention, a fuel cell system including a membrane/electrode assembly according to a preferred embodiment of the present invention comprises a fuel cell stack, an electrical load, a switch, and a control unit. The fuel cell stack includes a plurality of fuel cells, and the electrical load is selectively electrically connectable to the fuel cell stack through the switch which is actuated by a control signal of the control unit, and the control unit is configured to generate a control signal for turning on the switch when a shutdown of the fuel cell stack occurs.

In another preferred embodiment of the preset invention, the fuel cell system further comprises a voltage-monitoring device configured to monitor voltage of at least one of the fuel cells, and which is coupled to the control unit.

Preferably, the control unit is configured to generate a control signal for turning off the switch during shutdown of the fuel cell stack if it is determined that a voltage of at least one of the fuel cell becomes less than 0.2V.

Preferably, the fuel cell system according to a preferred embodiment of the present invention further comprises an intake air regulating valve disposed in an intake air line, an intake hydrogen regulating valve disposed in an intake hydrogen line, an exhaust air regulating valve disposed in an exhaust air line, and an exhaust hydrogen regulating valve disposed in an exhaust hydrogen line, and wherein the intake air regulating valve, the intake hydrogen regulating valve, the exhaust air regulating valve, and the exhaust hydrogen regulating valve are respectively actuated by control signals of the control unit, and are controlled to close during the shutdown of the fuel cell stack.

Preferably, the fuel cell system further comprises a connecting valve disposed in a connecting line, one end of the connecting line being connected to the exhaust air line at a position between the fuel cell stack and the exhaust air regulating valve, and the other end of the connecting line being connected to the exhaust hydrogen line at a position between the fuel cell stack and the exhaust hydrogen regulating valve, and wherein the connecting valve is actuated by a control signal of the control unit.

It is preferable that the control unit generates a control signal to open the connecting valve if it is determined that a voltage of the fuel cell stack is less than a predetermined voltage.

Preferably, the fuel cell system further comprises a recirculation pump disposed in a recirculation line, one end of the recirculation line being connected to the exhaust hydrogen line at a position between the fuel cell stack and the exhaust hydrogen regulating valve, and the other end of the recirculation line being connected to the intake hydrogen line at a position between the intake hydrogen regulating valve and the fuel cell stack, and wherein the recirculation pump is actuated by a control signal of the control unit.

It is preferable that the fuel cell system further comprises an air buffer tank disposed in the intake air line at a position between the intake air regulating valve and the fuel cell stack.

A volume of the air buffer tank is preferably determined such that a molar ratio of 2 to 1 of hydrogen to oxygen exists in a sealed space of the fuel cell stack when the intake air regulating valve, the intake hydrogen regulating valve, the exhaust air regulating valve, and the exhaust air regulating valve are closed.

Preferably, the fuel cell stack includes a nonporous separation plate, and the nonporous separate plate is disposed between the fuel cells.

### BRIEF DESCRIPTION OF THE DRAWINGS

The accompanying drawings, which are incorporated in and constitute a part of the specification, illustrate an embodiment of the invention, and, together with the description, serve to explain the principles of the invention, where:

FIG. 1 is a schematic sectional view of a fuel cell stack of a fuel cell system according to a preferred embodiment of the present invention;

FIG. 2 is a fuel cell system according to a preferred embodiment of the present invention.

### DETAILED DESCRIPTION OF THE PREFERRED EMBODIMENTS

Hereinafter, a preferred embodiment of the present invention will be described in detail with reference to the accompanying drawings.

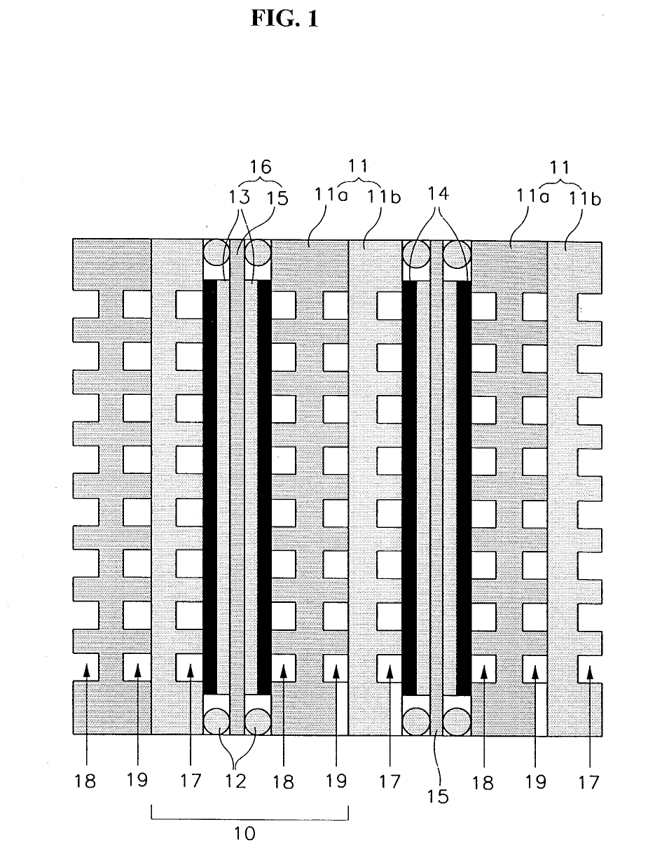

As shown in FIG. 1, a fuel cell stack of a fuel cell system according to a preferred embodiment of the present invention includes a plurality of fuel cells 10 connected in series.

Each of the fuel cells 10 has a membrane/electrode assembly (MEA) 16 including a polymer electrolyte membrane 15 positioned between a pair of electrodes (one anode electrode, one cathode electrode) 13.

The polymer electrolyte membrane 15 allows hydrogen ions to pass therethough, and the pair of electrodes 13 generate electricity through an electrochemical process. Gas diffusion media 14 are positioned on both sides of the MEA 16, and they diffuse fuel gas and air. An anode flow field plate 11b and a cathode flow field plate 11a are respectively disposed outside the gas diffusion media 14. The gas diffusion media 14 supply electric contact between the MEA 16 and flow field plates 11a and 11b.

Referring to FIG. 1, hydrogen passageways 17 are formed in the anode flow field plate 11b, and air passageways 18 are formed in the cathode flow field plate 11a. Coolant passageways 19 are formed between the cathode flow field plate 11a and the anode flow field plate 11b.

As shown in FIG. 1, the cathode flow field plate 11a and the anode flow field plate 11b are coupled to each other in a back-to-back manner, and the coupled cathode flow field plate 11a and the anode flow field plate 11b are disposed between the MEAs 16. For this reason, each pair of the coupled cathode flow field plate 11a and the anode flow field plate 11b is generally called a separate plate, which is designated by a reference numeral 11 in the drawing. Each pair of the coupled cathode flow field plate 11a and the anode flow field plate 11b is also commonly called a cooling plate because of the coolant passageways 19.

A gasket 12 is provided on both sides of the polymer electrolyte membrane 15 at each end thereof, in order to seal the fuel cell.

Preferably, in the fuel cell system according to the preferred embodiment of the present invention, the separate plate 11 is made of a nonporous material, in order to prevent coolant water from permeating the MEA 16.

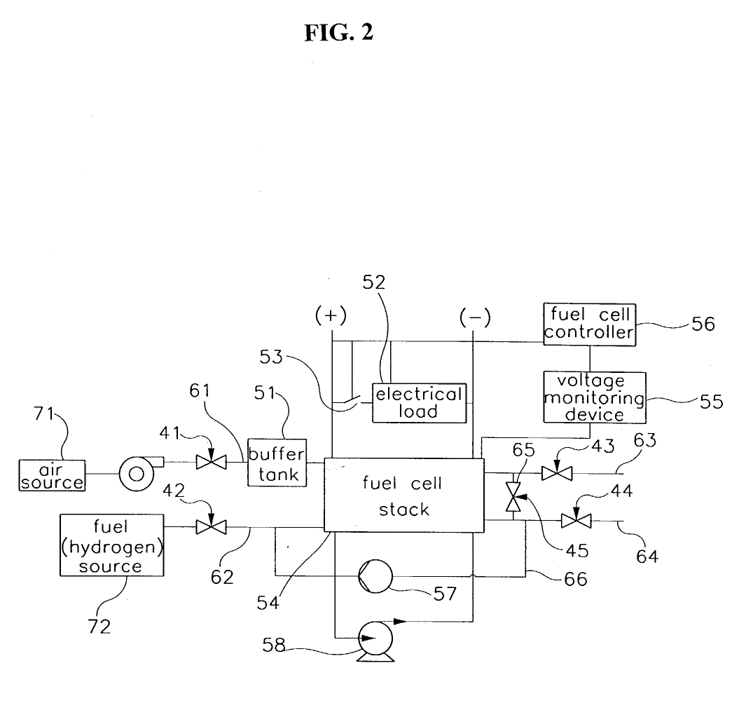

As shown in FIG. 2, the fuel cell system according to the preferred embodiment of the present invention includes a fuel cell stack 54. An intake air line 61 and a intake hydrogen line 62 are respectively formed at an inlet portion of the fuel cell stack 54, and an exhaust air line 63 and an exhaust hydrogen line 64 are respectively formed at an outlet portion of the fuel cell stack 54.

An intake air regulating valve 41 is disposed in the intake air line 61 connecting the fuel cell stack 54 and air source 71. An intake hydrogen regulating valve 42 is disposed in the intake hydrogen line 62 connecting the fuel cell stack 54 and fuel source 72. An exhaust air regulating valve 43 is disposed in the exhaust air line 63, and an exhaust hydrogen regulating valve 44 is disposed in the exhaust hydrogen line 64.

These valves 41, 42, 43, and 44 can be operated by control signals to selectively open/close the lines, and as an example, they can be solenoid valves.

A connecting line 65 is provided between the exhaust air line 63 and the exhaust hydrogen line 64. The connecting line 63 communicates with the exhaust air line 63 at a position between the fuel cell stack 54 and the exhaust air regulating valve 43, and with the exhaust hydrogen line 64 at a position between the fuel cell stack 54 and the exhaust hydrogen regulating valve 44. A connecting valve 45 is provided in the connecting line 63.

If the connecting valve 45 is open, the exhaust hydrogen line 64 communicates with the exhaust air line 63, thereby preventing pressure in the hydrogen passageway 17 of the fuel cell stack 54 and in the exhaust hydrogen line 64 from excessively lowering.

The connecting valve 45 can be operated by control signals to selectively open/close the connecting line 65, and as an example, it can be a solenoid valve. A buffer tank 51 is provided in the intake air line 61 at a position between the fuel cell stack 54 and the intake air regulating valve 41.

In the fuel cell system according to the preferred embodiment of the present invention, the fuel cell stack 54 is sealed by closing the valves 41 and 42, and if the fuel cell is shut down, 43 and 44. The buffer tank 51 is provided in order to regulate a ratio of air and hydrogen in the fuel cell stack 54.

It is preferable that a molar ratio of 2 to 1 of hydrogen to oxygen exists in a sealed space of the fuel cell stack during shutdown of the fuel cell, because two hydrogen atoms react with one oxygen atom. As roughly 20% of ambient air is oxygen, a volume of the buffer tank 51 can be determined so that a desired ratio of hydrogen and oxygen can be achieved.

The fuel cell system according to the preferred embodiment of the present invention includes an electrical load 52 that is electrically connectable to the anode and cathode of the fuel cell stack 54. As shown in the drawing, it is preferable that the electrical load 52 is connected to the fuel cell stack 54 through a switch 53. The switch 53 is configured to be turned off (open) and/or on (closed) through control signals of a fuel cell controller 56. As an example, the switch 53 can be a relay switch. The electrical load can be a general resistor, or it can be an arbitrary load equipped in a vehicle.

The control unit or fuel cell controller 56 preferably includes a processor, a memory, and other necessary hardware and software components as will be understood by persons skilled in the art, to permit the fuel cell controller 56 to communicate with sensors and execute the control functions described herein.

The fuel cell controller 56 turns on the switch 53 when fuel cell shutdown occurs such that the electrical load 52 is electrically connected to the fuel cell stack 54, and electricity generated in the fuel cell stack 54 is then consumed by the electrical load 52. Consequently, a speed of eliminating hydrogen from the fuel cell stack 54 increases so that shutdown time will substantially decrease. The fuel cell controller 56 is coupled to the valves 41, 42, 43, 44, and 45 and the switch 53, and it generates control signals to operate the same.

A voltage-monitoring device 55 for monitoring voltage of the fuel cell stack 54 is coupled to the fuel cell stack 54. The voltage-monitoring device 55 monitors voltage of the fuel cell stack 54, and outputs corresponding signals to the fuel cell controller 56.

The fuel cell controller 56 controls the operation of the switch 53 in response to signals indicative of fuel cell stack voltage detected by the voltage-monitoring device 55.

A recirculation line 66 connects the exhaust hydrogen line 64 at a position between the fuel cell stack 54 and the exhaust hydrogen regulating valve 44 with the intake hydrogen line 62 at a position between the intake hydrogen regulating valve 42 and the fuel cell stack 54. A recirculation pump 57 is disposed in the recirculation line 66.

In the fuel cell system according to the preferred embodiment of the present invention, during shutdown of the fuel cell stack 54, the fuel cell controller 56 outputs control signals to close the intake air regulating valve 41, the intake hydrogen regulating valve 42, the exhaust air regulating valve 43, and the exhaust hydrogen regulating valve 44.

The fuel cell controller 56 outputs a control signal to turn on the switch 53 so that the electrical load 52 consumes electricity generated by an electrochemical process of residual air and hydrogen in the fuel cell stack 54. Consequently, a speed of consumption of the residual hydrogen gas in the fuel stack 54 will increase.

The fuel cell controller 56 determines whether a reversion of voltage polarity of the fuel cell stack 54 occurs based on signal of the voltage-monitoring device 55. If so, the fuel cell controller 56 generated a control signal to open the switch 53 to prevent the fuel cell stack from operating abnormally. For example, if the voltage of at lease one of said fuel cells becomes less than 0.2V, a control signal is generated to open the switch 53.

The fuel cell controller 56 determines whether the voltage of some of the fuel cells of the fuel cell stack 54 becomes negative, based on signal of the voltage-monitoring device 55. If so, the fuel cell controller 56 generates a control signal to open the switch 53 to prevent the fuel cell stack from operating abnormally. Further, the fuel cell controller 56 generates a control signal to operate the recirculation pump 57, to maintain voltages of the fuel cell of the fuel cell stack 54 to be uniform.

The fuel cell controller 56 generates a control signal to open the connecting valve 45 to prevent a vacuum from developing in the hydrogen passageway 17. If the connecting valve 45 is opened, pressures on both sides of the MEA 16 become similar so that the MEA 16 is prevented from being damaged by a pressure difference between both sides thereof.

For example, if the residual hydrogen has been removed from the fuel cell stack 54 when the fuel cell system according to the present invention operates under standard atmospheric pressure, the pressure in the air passageway 18 becomes 0.8 bar and the pressure in the hydrogen passageway 17 becomes 0 bar. In this situation, if the connecting valve 45 is open, pressures in both the air passageway 18 and the hydrogen passageway 17 become 0.4 bar. Therefore, even if the pressure in the fuel cell stack 54 becomes negative compared to atmospheric pressure, the MEA 16 is kept sealed from coolant of the separation plate 11.

In the fuel cell system according to the preferred embodiment of the present invention, stable shutdown and startup can be obtained without an inert gas source. Therefore, the fuel cell system according to the preferred embodiment of the present invention can be easily applied to a vehicle. Furthermore, in the fuel cell system according to the preferred embodiment of the present invention, the shutdown time of the fuel cell is decreased substantially.

Although preferred embodiments of the present invention have been described in detail hereinabove, it should be clearly understood that many variations and/or modifications of the basic inventive concepts herein taught which may appear to those skilled in the present art will still fall within the sprit and scope of the present invention, as defined in the appended claims.

Throughout this specification and the claims which follow, unless explicitly described to the contrary, the word “comprise” or variations such as “comprises” or “comprising” will be understood to imply the inclusion of stated elements but not the exclusion of any other elements.

What is claimed is:

1. A fuel cell system including a membrane/electrode assembly, comprising:
fuel cell stack including a plurality of fuel cells;
an electrical load selectively electrically connectable with said fuel cell stack;
a switch configured to selectively connect said electrical load to said fuel cell stack; and
a control unit configured to generate a control signal for actuating said switch, said control unit generating a control signal for turning on said switch when a shutdown of said fuel cell stack occurs.

2. The fuel cell system of claim 1, further comprising a voltage-monitoring device configured to monitor voltage of at least one of said fuel cells and being coupled to said control unit.

3. The fuel cell system of claim 2, wherein said control unit is configured to generate a control signal for turning off said switch during said shutdown of said fuel cell stack if it is determined that a voltage of at least one of said fuel cells becomes less than 0.2V.

4. The fuel cell system of claim 1, further comprising:
an intake air regulating valve disposed in an intake air line;
an intake hydrogen regulating valve disposed in an intake hydrogen line;
an exhaust air regulating valve disposed in an exhaust air line; and
an exhaust hydrogen regulating valve disposed in an exhaust hydrogen line, and wherein said intake air regulating valve, said intake hydrogen regulating valve, said exhaust air regulating valve, and said exhaust hydrogen regulating valve are respectively actuated by control signals of said control unit, and are controlled to close during said shutdown of said fuel cell stack.

5. The fuel cell system of claim 4, further comprising a connecting valve disposed in a connecting line, one end of said connecting line being connected to said exhaust air line at a position between said fuel cell stack and said exhaust air regulating valve, and the other end of said connecting line being connected to said exhaust hydrogen line at a position between said fuel cell stack and said exhaust hydrogen regulating valve, and wherein said connecting valve is actuated by a control signal of said control unit.

6. The fuel cell system of claim 5, wherein said control unit generates a control signal to open said connecting valve if it is determined that a voltage of said fuel cell stack is less than a predetermined voltage.

7. The fuel cell system of claim 4, further comprising a recirculation pump disposed in a recirculation line, one end of said recirculation line being connected to said exhaust hydrogen line at a position between said fuel cell stack and said exhaust hydrogen regulating valve, and the other end of said recirculation line being connected to said intake hydrogen line at a position between said intake hydrogen regulating valve and said fuel cell stack, and wherein said recirculation pump is actuated by a control signal of said control unit.

8. The fuel cell system of claim 4, further comprising an air buffer tank disposed in said intake air line at a position between said intake air regulating valve and said fuel cell stack.

9. The fuel cell system of claim 8, wherein a volume of said air buffer tank is determined such that a molar ratio of 2 to 1 of hydrogen to oxygen exists in a sealed space of said fuel cell stack when said intake air regulating valve, said intake hydrogen regulating valve, said exhaust air regulating valve, and said exhaust air regulating valve are closed.

10. The fuel system of claim 1, wherein said fuel cell stack includes a nonporous separation plate, said nonporous separation plate being disposed between said fuel cells.

11. A fuel cell system comprising:
a fuel cell stack including at least one fuel cell;
an electrical load;
a switch configured to selectively connect said electrical load to said fuel cell stack; and
a control unit electrically coupled to said switch and configured to generate a control signal for turning on said switch when a shutdown of said fuel cell stack occurs.

12. The fuel cell system of claim 11, further comprising a voltage-monitoring device electrically coupled to said control unit and said fuel cell stack, wherein said voltage-monitoring device is configured to monitor a voltage of said fuel cell stack.

13. The fuel cell system of claim 12, wherein said control unit is configured to generate a control signal for opening said switch during said shutdown of said fuel cell stack if it is determined by said voltage-monitoring device that a voltage of said at least one fuel cell is less than 0.2V.

14. The fuel cell system of claim 11, further comprising:
an intake air regulating valve disposed in an intake air line coupled to said fuel cell stack;
an intake hydrogen regulating valve disposed in an intake hydrogen line coupled to said fuel cell stack;
an exhaust air regulating valve disposed in an exhaust air line coupled from said fuel cell stack; and
an exhaust hydrogen regulating valve disposed in an exhaust hydrogen line coupled from said fuel cell stack, wherein said intake air regulating valve, said intake hydrogen regulating valve, said exhaust air regulating valve, and said exhaust hydrogen regulating valve are respectively actuated by control signals of said control unit to close during said shutdown of said fuel cell stack.

15. The fuel cell system of claim 14, further comprising a connecting valve disposed in a connecting line, one end of said connecting line being connected to said exhaust air line at a position between said fuel cell stack and said exhaust air regulating valve, and the other end of said connecting line being connected to said exhaust hydrogen line at a position between said fuel cell stack and said exhaust hydrogen regulating valve, and wherein said connecting valve is actuated by a control signal of said control unit.

16. The fuel cell system of claim 15, wherein said control unit generates a control signal to open said connecting valve if it is determined that a voltage of said fuel cell stack is less than a predetermined voltage.

17. The fuel cell system of claim 14, further comprising a recirculation pump disposed in a recirculation line, one end of said recirculation line being connected to said exhaust hydrogen line at a position between said fuel cell stack and said exhaust hydrogen regulating valve, and the other end of said recirculation line being connected to said intake hydrogen line at a position between said intake hydrogen regulating valve and said fuel cell stack, and wherein said recirculation pump is actuated by a control signal of said control unit.

18. The fuel cell system of claim 14, further comprising an air buffer tank disposed in said intake air line at a position between said intake air regulating valve and said fuel cell stack.

19. The fuel cell system of claim 18, wherein a volume of said air buffer tank is determined such that a molar ratio of 2 to 1 of hydrogen to oxygen exists in a sealed space of said fuel cell stack when said intake air regulating valve, said intake hydrogen regulating valve, said exhaust air regulating valve, and said exhaust air regulating valve are closed.

20. The fuel system of claim 11, wherein said fuel cell stack includes a nonporous separation plate, said nonporous separation plate being disposed between said fuel cells.
